(19) United States
(12) Patent Application Publication
(10) Pub. No.: US 2022/0003080 A1
(43) Pub. Date: Jan. 6, 2022

(54) WATER REMOVAL FROM ELECTRIC SUBMERSIBLE PUMP SYSTEMS

(71) Applicant: Halliburton Energy Services, Inc., Houston, TX (US)

(72) Inventors: David Christopher Beck, Broken Arrow, OK (US); Walter Dinkins, Tulsa, OK (US)

(21) Appl. No.: 16/920,342

(22) Filed: Jul. 2, 2020

(51) Int. Cl. E21B 43/02; E21B 41/00; E21B 33/12; E21B 43/12

(52) U.S. Cl. CPC E21B 43/02; E21B 43/128; E21B 33/1208; E21B 41/0042

(57) ABSTRACT

An electric submersible pump includes a pump, an electric motor that is coupled to the pump by a rotatable shaft, a seal section that is positioned between the pump and the electric motor. The seal section contains a sequestration device and a motor oil for the electric motor. The sequestration device includes a superabsorbent polymer to contact the motor oil and to react with a wellbore fluid from a wellbore to prevent premature failure of the electric submersible pump from the wellbore fluid contamination of the motor oil.

### TECHNICAL FIELD

The present disclosure relates generally to an electric submersible pump and, more particularly (although not necessarily exclusively), to managing contaminants in an electric submersible pump system for use in a wellbore.

### BACKGROUND

In a hydrocarbon well, an electric submersible pump may be used to move wellbore fluid from downhole to the surface, such as by using artificial lift for hydrocarbon extraction. An electric submersible pump may be used to manage the pressure of the fluid or the flow of fluid extracted from the wellbore.

An electric submersible pump may contain one or more electric submersible motors, one or more seal sections, and one or more pumps, and can be positioned downhole in a wellbore. Electric submersible pumps in wellbore operations can be positioned at depths of at great depths and operate under extreme temperate and pressure conditions. The electric submersible motors may be filled with motor oil to provide a fluid film for bearing operation and provide dielectric resistance between the rotor and stator. Infiltration of contaminants, including wellbore fluids, into the electric submersible pump motor oil can degrade the lubricity and dielectric characteristics of the motor oil and can increase the likelihood of premature failure of the electric submersible pump due to an electrical fault. The effects of premature failure of an electric submersible pump include costly maintenance activities and lost production from the wellbore.

### BRIEF DESCRIPTION OF THE DRAWINGS

FIG. 1 is a schematic of a wellbore in which an electric submersible pump with a seal section is positioned to communicate with surface equipment according to one example of the present disclosure.

FIG. 2 is a partial cross-sectional schematic of a seal section that can be installed in an electric submersible pump and includes sequestration devices according to one example of the present disclosure.

FIG. 3 is a partial cross-sectional schematic of a seal section that can be installed in an electric submersible pump and includes sequestration devices and circulation-inducing mechanisms according to one example of the present disclosure.

FIG. 4 is a partial cross-sectional schematic of a motor section that can be installed in an electric submersible pump and includes sequestration devices according to one example of the present disclosure.

FIG. 5 is a cross-sectional schematic of a seal section that includes a seal bag with a sequestration device according to one example of the present disclosure.

FIG. 6 is a flowchart of a process for absorbing a wellbore fluid contaminant according to one example of the present disclosure.

### DETAILED DESCRIPTION

Certain aspects and examples of the present disclosure relate to a device that can be used in a seal section of an electric submersible pump to sequester contaminants, including wellbore fluids. The device can include superabsorbent polymers or other components to sequester wellbore fluids that infiltrate into a seal section, and to prevent the wellbore fluids from degrading the motor oil in the electric submersible pump. For example, a device that includes superabsorbent polymers can react with wellbore fluids or otherwise bind wellbore fluids that leaked into the seal section so that the wellbore fluids are no longer available to react or otherwise alter the properties of the motor oil in the electric submersible pump.

Sequestration of the wellbore fluids into locations where they cannot degrade the motor oil characteristics can prolong the operational life of the motor by preventing or delaying failure due to motor oil contamination. Postponing potential failures of the motor can increase the run-life of an electric submersible pump system downhole.

The sequestration device can include a sequestration agent that can react with wellbore fluids or otherwise bind wellbore fluids that leaked into the seal section of the pump, but not adversely affect the dielectric and lubricity characteristics of the motor oil. Wellbore fluids may include water and a myriad of other polar compounds. A polar compound can be a covalently bonded substance with an electric dipole moment caused by positive and negative charged ends of the compound.

In some examples, the sequestration agent is a superabsorbent polymer. In response to contact with the water or other polar substance, superabsorbent polymers can absorb polar and other aqueous compounds through hydrogen bonding. The degree of crosslinking within the superabsorbent polymer can change the total absorbency and swelling capacity of the super absorbent polymer. Low-density, cross-linked superabsorbent polymers may have a higher absorbent capacity and increased swell volume. High cross-link density polymers may have a lower absorbent capacity and reduced swell volume. High cross-link density polymers can be more rigid than low cross-link density polymers and may maintain the particle shape of the high cross-link density polymers, even under modest pressure.

Superabsorbent polymers for the sequestration device may be acrylic-acid based. Sodium polyacrylate, a poly-acrylic acid sodium salt, is a superabsorbent polymer that may be employed in the device. Other superabsorbent polymers for use in the device may be based on polyacrylamide copolymer, ethylene maleic anhydride copolymer, cross-linked carboxymethylcellulose, polyvinyl alcohol copolymers, cross-linked polyethylene oxide, or a starch-grafted copolymer of polyacrylonitrile.

A device that includes superabsorbent polymers can absorb many times its weight in water or other polar fluid before becoming saturated and no longer be able to actively sequester a wellbore fluid contaminant. The superabsorbent polymer in the device may be in the form of a powder, granules, pellets, beads, or a gel. Some superabsorbent polymers can quickly absorb up to 100, 200, 300, 500, 700, or 1000 times their weight in water.

The sequestration of wellbore fluids in the seal section can continue during operations until the device becomes saturated or reaches capacity with the wellbore fluids. The motor oil may be nonpolar and nonreactive with the superabsorbent polymer. Water and other polar compounds may degrade the characteristics of the motor oil, such as lubricity and dielectric properties. When the device is in operation, degradation of the motor oil characteristics due to contamination from water or other polar compounds can be slowed or delayed, and possible failures due to imbalance of bearing forces or electrical failure can be postponed.

In some examples, the sequestration device can be a filter. The filter can include a frame with a sequestering agent, such as a superabsorbent polymer integrated with a cover that engages with the frame. Sequestration may be achieved when wellbore fluid contaminants contact the cover of the filter. The cover may be permeable to not restrict flow of motor oil within the seal section. The cover may have a pore size that is sized to ensure the filter does not become plugged during operation of the pump.

The sequestration device can be a vessel or canister filled with an agent such as a superabsorbent polymer. The vessel or canister can be positioned at a location for the motor oil to flow through the vessel or canister. The vessel may have an inlet and an outlet, and sequestration may be achieved when wellbore fluid contaminants flow through the vessel and contact the sequestration agent within the vessel. The vessel can be structured to avoid restricting the flow of motor oil within the seal section or to avoid reducing the availability of the motor oil in the seal section for operations of the pump. The agent may be in powder, granule, or pellet form. The packing density of the agent and particle size of the agent may be selected to ensure the vessel does not become plugged during operation of the pump.

The sequestration device can be a nanofiber structure that may be impregnated or dispersed with a sequestration agent. The sequestration device can be a nanofiber polymer structure coated with a sequestration agent. The nanofiber structure may have a mesh, web, or open weave design to provide a high surface area to contact the motor oil and sequester the wellbore fluid contaminant.

In some examples, the motor oil in the seal sections of an electric submersible pump may be contained in chambers, surrounded by polymer bags for a positive barrier against wellbore fluid infiltration. The polymer bags can provide space for thermal expansion of the motor oil and serve as a barrier between the wellbore fluid and the electric motor. In some cases, a tear may develop in the bag downhole that can result in wellbore fluid entering through the breached bag into the chamber holding the motor oil. In other cases, wellbore fluid infiltration can occur through leaks in the pump housing or at the mechanical face seals around the pump shafts between seal sections.

The sequestration device can be positioned within the polymer bags of a seal section. In some examples, the sequestration device can be coupled to the polymer bag. In other examples, the sequestration device can be coupled to a rotatable shaft or a mechanical face seal. The sequestration device can be positioned within the motor section of the electric submersible pump. In some examples, the sequestration device can be positioned at the head and base of the motor. In certain examples, sequestration devices can be positioned within the polymer bags of a seal section and within the motor section. One sequestration device or more than one sequestration device may be used in each seal section and/or motor section of the electric submersible pump.

In some examples, a circulation-inducing mechanism may be used with the sequestration devices to displace the motor oil and induce movement of the motor oil within the seal sections or motor sections of the electric submersible pump. The movement of the circulation-inducing mechanism can increase contact between the sequestration devices and the wellbore fluid contaminate. The circulation device can be positioned near the sequestration devices and may be coupled to the rotatable shaft or mechanical seal face of the electric submersible pump. Examples of circulation-inducing mechanism include an auger, blades, fins, or eductor integrated with the rotatable components of the electric submersible pump. The increased movement of the motor oil within the seal section can provide for greater contact with the agent and improved sequestration of wellbore fluid contaminants from the motor oil.

The sequestration devices can operate continuously to remove wellbore fluid contaminants from the motor oil of the electric submersible pump. The sequestration devices and agents may be resilient to the high temperature and pressure conditions of downhole operations.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

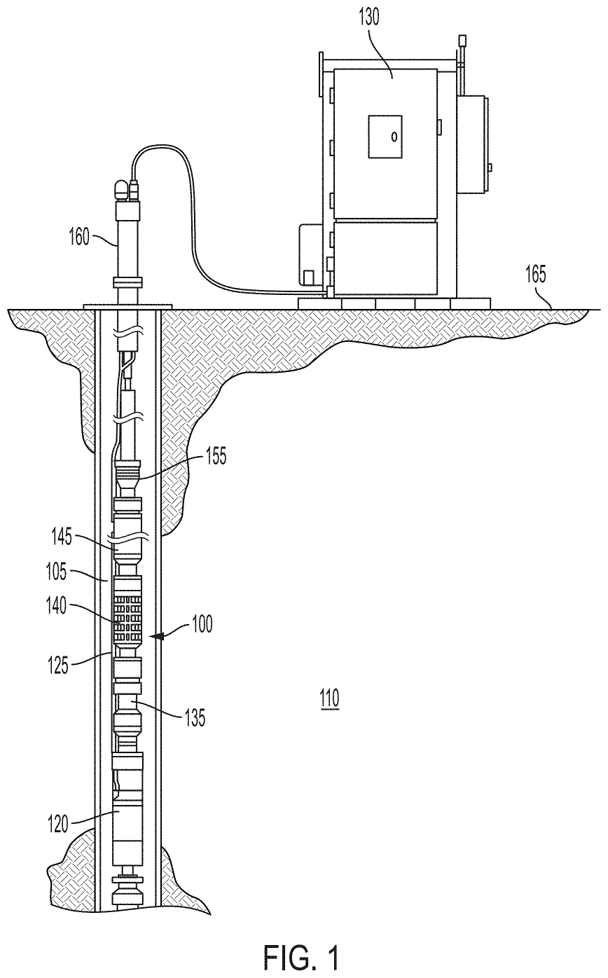

FIG. 1 is a schematic of a wellbore 105 in which an electric submersible pump 100, with a seal section 135 that includes a sequestration device, is positioned to communicate with surface equipment according to one example of the present disclosure. The wellbore 105 can be in a subterranean environment 110 and the electric submersible pump 100 may provide artificial lift to wellbore fluid by moving wellbore fluid from a position downhole to a surface 165 through a wellhead 160. Artificial lift can be employed during the production phase of a hydrocarbon well after subterranean pressures have abated and a free-flow stage of the well has ended. The electric submersible pump 100 in the wellbore 105 can provide artificial lift to maintain the production rate from the wellbore 105.

The electric submersible pump 100 can have an electric motor 120 coupled to a pump 145 by a shaft to provide mechanical power to the pump 145 from the electric motor 120. The pump 145 may have an intake 140 and a discharge 155. The intake 140 can allow the pump 145 to draw in wellbore fluid and direct the wellbore fluid toward the surface 165 through the discharge 155. The electric motor 120 may be electrically coupled to a variable speed controller 130 by a cable 125. The variable speed controller 130 can provide both power and control signals to the electric motor 120 through the cable 125. The variable speed controller 130 and the wellhead 160 may be positioned above the surface 165.

Between the pump 145 and the electric motor 120 is at least one seal section 135 that can contain at least one sequestration device inside the seal section 135. The seal section 135 can transfer torque to the pump 145 from the electric motor 120. The seal section 135 can prevent wellbore fluid from contaminating motor oil for the electric motor 120 through isolation, equalization, and expansion. The seal section 135 may also prevent pump-shaft thrust from impacting motor performance through force absorption. The seal section 135 can isolate the electric motor 120 from wellbore fluid that can otherwise cause electrical and mechanical faults of the electric motor 120.

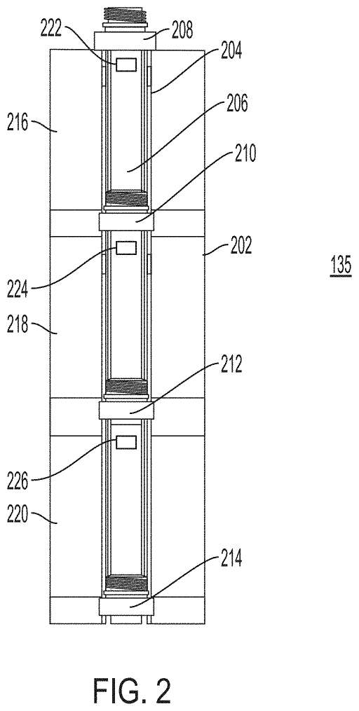

FIG. 2 is a partial cross-sectional schematic of a seal section 135 that can be installed in an electric submersible pump and that includes seal bags 216-220, each with a sequestration device according to one example of the present disclosure. As depicted, the seal section 135 is depicted as having three sections defined between mechanical seals 208-214 and including seal bags 216-220 and sequestration devices 222-226. Each of the seal bags 216-220 is positioned within an outer housing 202. Although three sequestration devices 222-226 are shown in FIG. 2, a seal section according to other examples can have any number of sequestration devices, including one sequestration device, two sequestration devices, or more than three sequestration devices.

The seal section 135 also includes a guide tube 204 in which is positioned a shaft 206. The shaft 206 can couple an electric motor to a pump of the electric submersible pump. The mechanical seals 208-214 can prevent fluid from entering the seal section 135 around the shaft 206 through the guide tube 204. The seal bags 216-220 can further isolate the electric motor and prevent ingress of wellbore fluid due to the failure of one of the mechanical seals 208-214.

In this example, the three sections in the seal section 135 may provide redundant protection for the electric motor 120. If one of the three sections fails, the electric motor can still function without contamination from wellbore fluid. For example, the seal bag in a section may develop a leak and the motor oil may be exposed to wellbore fluid. The sequestration device may absorb water and other polar compounds from wellbore fluid contamination in response to the breach of the bag. The sequestration device can react with the wellbore fluid and prevent contamination from reaching the motor.

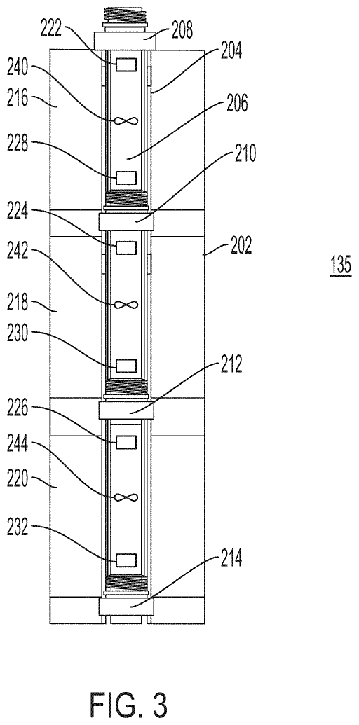

FIG. 3 is a partial cross-sectional schematic of a seal section 135 that can be installed in an electric submersible pump and that includes sequestration devices in each seal bag according to one example of the present disclosure. As depicted, the seal section 135 has three sections defined between mechanical seals 208-214 and has seal bags 216-220 positioned within an outer housing 202. Each section includes two of the sequestration devices 222-232. Although six sequestration devices 222-232 are shown in FIG. 3, including two per seal section, a seal section according to other examples can have any number of sequestration devices, including one. The sequestration devices 222-232 may absorb water and other polar compounds from wellbore fluid entering the seal sections in response to breaching the bag. The sequestration devices 222-232 can react with the wellbore fluid and prevent the wellbore fluid from reaching the motor and contaminating the motor. The sequestration devices 222-232 may avoid absorbing nonpolar compounds, such as motor oil. The sequestration devices 222-232 may normally be in a non-absorbing state when contacting motor oil that is substantially free of polar compounds from wellbore fluid. The sequestration devices 222-232 can absorb polar compounds from wellbore fluid, such as water, in response to a breach of the seal bag and contact with the polar compounds.

The seal section 135 can also include a circulation-inducing mechanism 240-244 within each of the three sections, where the circulation-inducing mechanisms 240-244 may be positioned on the shaft 206 and configured to rotate as the shaft 206 rotates. In this example, the circulation-inducing mechanisms 240-244 may provide more efficient sequestration of water and other polar compounds in the motor oil and prevent the wellbore fluids from reaching the motor section by increasing contact between the sequestration devices and wellbore fluids within the motor oil. As the shaft 206 rotates, the circulation-inducing mechanisms 240-244 can induce flow and circulation of the motor oil within each seal bag 216-220 to provide for the motor oil and any contaminants therein to flow through and have increased contact with the sequestration devices 222-232. This increased contact can provide for greater sequestration of any water or other polar compounds as the sequestration devices 222-232 absorb water and other polar compounds in the wellbore fluid contamination in response to a breach of the seal bag. The flow and circulation of the motor oil within the bag may aid in the removal of the contaminant from the motor oil within the seal and prevent wellbore fluid contamination from reaching the motor.

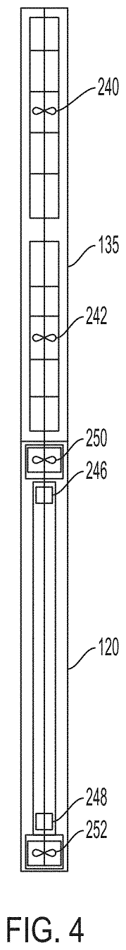

FIG. 4 is a cross-sectional schematic of seal section 135 and an electric motor 120 that includes two sequestration devices 246-248 and two circulation-inducing mechanisms 250-252 according to one example of the present disclosure. The sequestration devices 246-248 can be positioned adjacent to the electric motor, in particular, the sequestration devices may be positioned at a head and a base of the electric motor 120. In this example, the circulation-inducing mechanisms 250-252 may provide for sequestration of water and other polar compounds in the motor oil in sequestration devices 246-248 and delay the impact of the contaminants on the dielectric and lubricity characteristics of the motor oil within motor section 120 by increasing contact between the sequestration devices 246-248 and contaminants within the motor oil. As the shaft 206 rotates, the circulation-inducing mechanisms 250-252 can induce flow and circulation of the motor oil within the motor section 120 to provide for the motor oil and any contaminants therein to flow through and/or have increased contact with the sequestration devices 246-248. This increased contact can provide for greater sequestration of any water or polar compounds as the sequestration devices absorb water and other polar wellbore fluid contamination in response to a breach of the motor section 120. The sequestration devices 246-248 can be positioned within the electric motor, in particular, the sequestration devices may be positioned within a head or within a base of the electric motor 120. The sequestration devices 246-248 may avoid absorbing nonpolar compounds, such as motor oil. The sequestration devices 246-248 may normally be in a non-absorbing state when contacting motor oil that is substantially free of polar compounds from wellbore fluid. The sequestration devices 246-248 can absorb polar compounds from wellbore fluid, such as water, in response to a breach of the motor section 120 and contact with the polar compounds. The flow and circulation of the motor oil through sequestration devices 246-248 may aid in the removal of the contaminant from the motor oil and extend the run time of the motor in the event wellbore fluid contamination reaches the motor section 120.

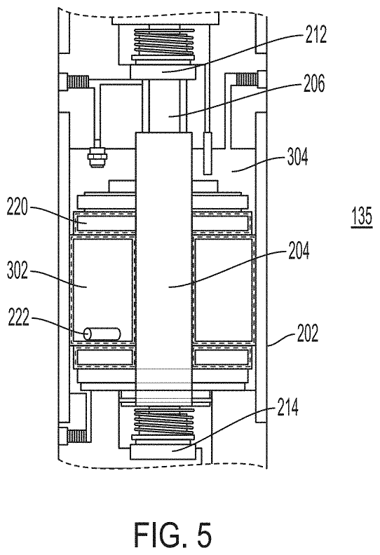

FIG. 5 is a cross-sectional schematic of a seal section 135 that includes a seal bag 220 with a sequestration device 222 according to one example of the present disclosure. The seal section 135 can have an outer housing 202 that can be a pipe that may be bounded at each end by a head and a base. Check valves within the head and base can allow motor oil to move within the seal section 135 to maintain a constant and slightly positive pressure through the seal section 135 relative to the wellbore pressure at the pump intake.

The seal bag 220 can be positioned inside the outer housing 202 in the seal section 135 between mechanical face seals 212, 214. A guide tube 204 can be positioned axially within the seal section 135 and can define a cavity in which a shaft 206 can rotate to transfer power from the electric motor to the pump of an electric submersible pump.

Motor oil can fill an interior volume 302 of the seal bag 220 and the external volume 304 that is inside the outer housing 202. If the mechanical face seal 212 fails, the seal section 135 between the mechanical face seals 212 and 214 can be contaminated with wellbore fluid. In this example, the sequestration device 222 can protect the motor from contaminated motor oil by absorbing the wellbore fluid in seal section 135.

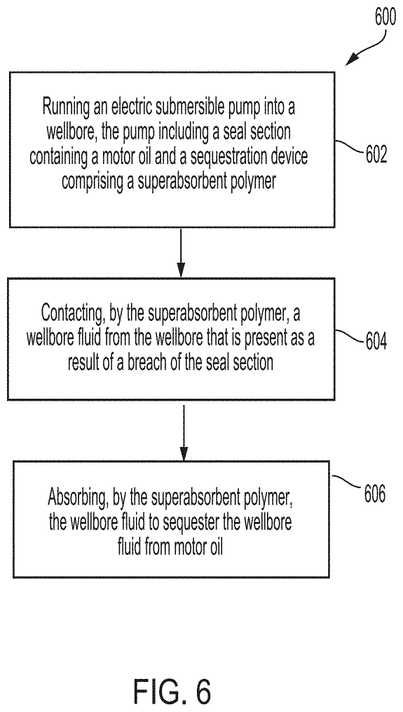

FIG. 6 is a flowchart of a process 600 for sequestering a wellbore fluid contaminant in seal section according to one example of the present disclosure. In block 602, an electric submersible pump is run downhole into a wellbore. The electric submersible pump can be run downhole using a conveyance mechanism such as coiled tube or wireline. The electric submersible pump can include an electric motor and a pump coupled by a shaft that transmits power from the electric motor to the pump. The electric motor can power the pump so that the pump provides artificial lift for the wellbore. One or more seal sections can be positioned between the electric motor and the pump. The seal section can include a seal bag that has a sequestration device. The sequestration device may contain a superabsorbent polymer. The seal sections can isolate the electric motor from wellbore fluids.

In block 604, the sequestering agent, e.g., a superabsorbent polymer, of the sequestration device contacts water or other polar wellbore fluid contaminate that may enter the motor oil due to a leak in the system. The leak may be at the rotatable mechanical face seal at the connection of each seal section, from the housing of seal section, or from a bag within the seal section.

In block 606, the sequestering agent, e.g., a superabsorbent polymer, of the sequestration device reacts with the water or other polar wellbore fluid contaminate to absorb the contaminate and prevent it from reaching the electric motor. During operation of the electric submersible pump, the sequestration device can continually absorb water or other polar compounds that infiltrates the motor oil in the seal section.

In some aspects, electric submersible pumps, sequestration devices, seals, and methods for sequestering water or other polar wellbore fluids are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is an electric submersible pump, comprising: a pump, an electric motor that is coupled to the pump by a rotatable shaft, a seal section positioned between the pump and the electric motor for containing a motor oil for the electric motor, and a sequestration device comprising a superabsorbent polymer positioned in the seal section to contact the motor oil and to react with a wellbore fluid from a wellbore.

Example 2 is the electric submersible pump of example(s) 1, wherein the wellbore fluid is a polar compound.

Example 3 is the electric submersible pump of example(s) 1-2, wherein the sequestration device is nonreactive with the motor oil.

Example 4 is the electric submersible pump of example(s) 1-3, wherein the seal section comprises an outer housing and a seal bag internal to the outer housing, and wherein the sequestration device is positioned within the seal bag.

Example 5 is the electric submersible pump of example(s) 1-4, wherein the superabsorbent polymer is positioned to react with the wellbore fluid through hydrogen bonding.

Example 6 is the electric submersible pump of example(s) 1-5, wherein the superabsorbent polymer is an acrylic-acid polymer, a polyacrylamide copolymer, an ethylene maleic anhydride copolymer, a cross-linked carboxymethylcellulose, a polyvinyl alcohol copolymer, a cross-linked polyethylene oxide, or a starch-grafted copolymer of polyacrylonitrile.

Example 7 is the electric submersible pump of example(s) 1-6, wherein the superabsorbent polymer has an absorbency with the wellbore fluid in an amount of up to 1000 times greater than a weight of the superabsorbent polymer.

Example 8 is the electric submersible pump of example(s) 1-7, wherein superabsorbent polymer is in a form of a powder, granules, pellets, beads, or a gel contained by a structure, the superabsorbent polymer having a packing density in the structure to provide for the superabsorbent polymer to swell from contact with the wellbore fluid.

Example 9 is the electric submersible pump of example(s) 1-8, further comprising a second sequestration device comprising a superabsorbent polymer, the second sequestration device positioned adjacent to the electric motor or within the electric motor to contact the motor oil and to react with the wellbore fluid from the wellbore.

Example 10 is the electric submersible pump of example(s) 1-9, further comprising a circulation-inducing mechanism to displace the motor oil in the seal section and to increase contact between the wellbore fluid and the sequestration device.

Example 11 is the electric submersible pump of example(s) 10, wherein the circulation-inducing mechanism is an auger, one or more blades, one or more fins, or an eductor coupled to the rotatable shaft.

Example 12 is a seal comprising: an outer housing positionable between a pump and an electric motor of an electric submersible pump, a seal bag internal to the outer housing, and a sequestration device internal to the seal bag, the sequestration device including a superabsorbent polymer to contact a motor oil in the seal bag and to react with a wellbore fluid in the seal as a result of a breach in the seal.

Example 13 is the seal of example(s) 12, wherein the superabsorbent polymer is an acrylic-acid polymer, a polyacrylamide copolymer, an ethylene maleic anhydride copolymer, a cross-linked carboxymethylcellulose, a polyvinyl alcohol copolymer, a cross-linked polyethylene oxide, or a starch-grafted copolymer of polyacrylonitrile.

Example 14 is the seal of example(s) 12-13, wherein the wellbore fluid is a polar compound capable of hydrogen bonding with the superabsorbent polymer.

Example 15 is the seal of example(s) 12-14, further comprising an auger, one or more blades, one or more fins, or an eductor coupled to the rotatable shaft to displace the motor oil and to increase contact between the wellbore fluid and the sequestration device.

Example 16 is the seal of example(s) 12-15, wherein the sequestration device comprises a filter, a canister, or a nanofiber structure sized to contain the superabsorbent polymer and to avoid restriction of flow of motor oil within the seal section.

Example 17 is the seal of example(s) 12-16, wherein the superabsorbent polymer is in a form of a powder, granules, pellets, beads, or a gel having a packing density to provide for the superabsorbent polymer to swell from contact with the wellbore fluid.

Example 18 is a method comprising: positioning an electric submersible pump into a wellbore, the electric submersible pump including a pump, an electric motor coupled to the pump, a seal section, a sequestration device in the seal section, and a motor oil in the seal section, the sequestration device including a superabsorbent polymer, contacting, by the superabsorbent polymer, a wellbore fluid in the motor oil, the wellbore fluid present as a result of a breach of the seal section, and absorbing, by the superabsorbent polymer, the wellbore fluid to sequester the wellbore fluid from the motor oil.

Example 19 is the method of example(s) 18, wherein the superabsorbent polymer substantially prevents the wellbore fluid from contacting the electric motor.

Example 20 is the method of example(s) 18-19, wherein the wellbore fluid is a polar compound.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. An electric submersible pump, comprising:
a pump;
an electric motor that is coupled to the pump by a rotatable shaft;
a seal section positioned between the pump and the electric motor for containing a motor oil for the electric motor; and
a sequestration device comprising a superabsorbent polymer positioned in the seal section to contact the motor oil and to react with a wellbore fluid from a wellbore.

2. The electric submersible pump of claim 1, wherein the wellbore fluid is a polar compound.

3. The electric submersible pump of claim 1, wherein the sequestration device is nonreactive with the motor oil.

4. The electric submersible pump of claim 1, wherein the seal section comprises an outer housing and a seal bag internal to the outer housing, and wherein the sequestration device is positioned within the seal bag.

5. The electric submersible pump of claim 1, wherein the superabsorbent polymer is positioned to react with the wellbore fluid through hydrogen bonding.

6. The electric submersible pump of claim 1, wherein the superabsorbent polymer is an acrylic-acid polymer, a polyacrylamide copolymer, an ethylene maleic anhydride copolymer, a cross-linked carboxymethylcellulose, a polyvinyl alcohol copolymer, a cross-linked polyethylene oxide, or a starch-grafted copolymer of polyacrylonitrile.

7. The electric submersible pump of claim 1, wherein the superabsorbent polymer has an absorbency with the wellbore fluid in an amount of up to 1000 times greater than a weight of the superabsorbent polymer.

8. The electric submersible pump of claim 1, wherein the superabsorbent polymer is in a form of a powder, granules, pellets, beads, or a gel contained by a structure, the superabsorbent polymer having a packing density in the structure to provide for the superabsorbent polymer to swell from contact with the wellbore fluid.

9. The electric submersible pump of claim 1, further comprising a second sequestration device comprising a second superabsorbent polymer, the second sequestration device positioned adjacent to the electric motor or within the electric motor to contact the motor oil and to react with the wellbore fluid from the wellbore.

10. The electric submersible pump of claim 1, further comprising a circulation-inducing mechanism to displace the motor oil in the seal section and to increase contact between the wellbore fluid and the sequestration device.

11. The electric submersible pump of claim 10, wherein the circulation-inducing mechanism is an auger, one or more blades, one or more fins, or an eductor coupled to the rotatable shaft.

12. A seal comprising:
an outer housing positionable between a pump and an electric motor of an electric submersible pump;
a seal bag internal to the outer housing; and
a sequestration device internal to the seal bag, the sequestration device including a superabsorbent polymer to contact a motor oil in the seal bag and to react with a wellbore fluid in the seal as a result of a breach in the seal.

13. The seal of claim 12, wherein the superabsorbent polymer is an acrylic-acid polymer, a polyacrylamide copolymer, an ethylene maleic anhydride copolymer, a cross-linked carboxymethylcellulose, a polyvinyl alcohol copolymer, a cross-linked polyethylene oxide, or a starch-grafted copolymer of polyacrylonitrile.

14. The seal of claim 12, wherein the wellbore fluid is a polar compound capable of hydrogen bonding with the superabsorbent polymer.

15. The seal of claim 12, further comprising an auger, one or more blades, one or more fins, or an eductor coupled to a rotatable shaft to displace the motor oil and to increase contact between the wellbore fluid and the sequestration device.

16. The seal of claim 12, wherein the sequestration device comprises a filter, a canister, or a nanofiber structure sized to contain the superabsorbent polymer and to avoid restriction of flow of motor oil within the seal.

17. The seal of claim 12, wherein the superabsorbent polymer is in a form of a powder, granules, pellets, beads, or a gel having a packing density to provide for the superabsorbent polymer to swell from contact with the wellbore fluid.

18. A method comprising:
positioning an electric submersible pump into a wellbore, the electric submersible pump including a pump, an electric motor coupled to the pump, a seal section, a sequestration device in the seal section, and a motor oil in the seal section, the sequestration device including a superabsorbent polymer;
contacting, by the superabsorbent polymer, a wellbore fluid in the motor oil, the wellbore fluid present as a result of a breach of the seal section; and
absorbing, by the superabsorbent polymer, the wellbore fluid to sequester the wellbore fluid from the motor oil.

19. The method of claim 18, wherein the superabsorbent polymer substantially prevents the wellbore fluid from contacting the electric motor.

20. The method of claim 18, wherein the wellbore fluid is a polar compound.
